(19) United States
(12) Patent Application Publication
(10) Pub. No.: US 2019/0263239 A1
(43) Pub. Date: Aug. 29, 2019

(54) Vehicle Hail Protection

(71) Applicant: Patrick P. Chen, Plano, TX (US)

(72) Inventor: Patrick P. Chen, Plano, TX (US)

(21) Appl. No.: 16/282,022

(22) Filed: Feb. 21, 2019

Related U.S. Application Data
(60) Provisional application No. 62/634,720, filed on Feb. 23, 2018.

(51) Int. Cl. B60J 11/04

(52) U.S. Cl. CPC B60J 11/04

(57) ABSTRACT

Novel tools and techniques are provided for implementing hail protection, and, more particularly, to methods, systems, and apparatuses for implementing vehicle hail protection. In some aspects, a device can provide protection for a vehicle and its occupants during a hailstorm. The device might be generally ovoid or elliptical and flat or (slightly) convex in shape, comprising single (or multiple) distinct airtight compartments (or layers) that can each inflate separately. The device might be fabricated from a relatively light, airtight, and waterproof material. When protection from hailstone is needed, the device can be quickly placed over the top of the vehicle, secured, then inflated with an air pump that plugs into a vehicle's cigarette lighter socket, USB port, or electrical outlet, or the like. Once inflated, the device is ready to provide an air-cushion barrier against falling hailstone. The device may be attached to a vehicle utilizing several straps.

### CROSS-REFERENCES TO RELATED APPLICATIONS

This application claims priority to U.S. Patent Application Ser. No. 62/634,720 (the “'720 Application”), filed Feb. 23, 2018 by Patrick P. Chen (attorney docket no. 0904.01PR), entitled, “Vehicle Hail Protection,” the disclosure of which is incorporated herein by reference in its entirety for all purposes.

### COPYRIGHT STATEMENT

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

### FIELD

The present disclosure relates, in general, to methods, systems, and apparatuses for implementing hail protection, and, more particularly, to methods, systems, and apparatuses for implementing vehicle and personal hail protection.

### BACKGROUND

Hail damage to vehicles is a costly and inconvenient possibility for those who live in areas of the country prone to hail and other sudden winter weather conditions. Conventional hail prevention or protection devices, however, are difficult to deploy, in some cases, requiring persons to stand outside the vehicle during the entire deployment process of the device (which exposes the persons themselves to injury from hail). Conventional devices also do not appear to give the option to comprise multiple layers or compartments that provide users with flexibility to protect against different sizes or severity of hail or the like.

Hence, there is a need for more robust and scalable solutions for implementing hail protection, and, more particularly, to methods, systems, and apparatuses for implementing vehicle and personal hail protection.

### BRIEF DESCRIPTION OF THE DRAWINGS

A further understanding of the nature and advantages of particular embodiments may be realized by reference to the remaining portions of the specification and the drawings, in which like reference numerals are used to refer to similar components. In some instances, a sub-label is associated with a reference numeral to denote one of multiple similar components. When reference is made to a reference numeral without specification to an existing sub-label, it is intended to refer to all such multiple similar components.

FIG. 1 is a schematic diagram illustrating a system for implementing vehicle and personal hail protection, in accordance with various embodiments.

FIG. 2 is a schematic diagram illustrating a perspective view of the system of FIG. 1 for implementing vehicle and personal hail protection.

FIG. 3 is a schematic diagram illustrating a top view of the system of FIG. 1 for implementing vehicle and personal hail protection as placed over a vehicle.

FIG. 4 is a schematic diagram illustrating a front elevation view of the system of FIG. 3 for implementing vehicle and personal hail protection as placed over a vehicle.

FIG. 5 is a schematic diagram illustrating another embodiment of a system for implementing vehicle and personal hail protection.

FIG. 6 is a schematic diagram illustrating a front elevation view of the system of FIG. 5 for implementing vehicle and personal hail protection as placed over a vehicle.

FIG. 7 is a schematic diagram illustrating a top or bottom view of yet another embodiment of a system for implementing vehicle and personal hail protection for placement over a vehicle.

FIG. 8 is a flow diagram illustrating a method for implementing vehicle and personal hail protection, in accordance with various embodiments.

### DETAILED DESCRIPTION OF CERTAIN EMBODIMENTS

### Overview

Various embodiments provide tools and techniques for implementing hail protection, and, more particularly, to methods, systems, and apparatuses for implementing vehicle and personal hail protection.

In some aspects, a device can provide protection for a vehicle and its occupants during a hailstorm by minimizing the damaging effects of falling hailstone. The device might be generally ovoid or elliptical and flat or (slightly) convex in shape, comprising single (or multiple) distinct airtight compartments (or layers) that can each inflate separately. The device might be fabricated from a relatively light, airtight, and waterproof material. When protection from hailstone is needed, the device can be quickly placed over the top of the vehicle, secured, then inflated with an air pump that plugs into a vehicle's cigarette lighter socket, USB port, or electrical outlet (e.g., 100 V outlet, 110 V outlet, 220 V outlet, or 100-220 V outlet, etc.), or the like. Once inflated, the device is ready to provide an air-cushion barrier against falling hailstone. The device may be attached to a vehicle utilizing three or four straps (although only two are shown in the figures). For most vehicles, one strap is placed along the front window (also referred to as the A pillar), one or two straps close to the B and/or C pillars (or the back window). Once the device is placed on top of the vehicle, each strap wraps around the top of the device through the appropriate slots, and the ends are brought together inside the vehicle. The two ends of each strap are secured to each other by Velcro, buckles, clips, strap and ratchet device, strap and buckle device, belt and buckle device, and/or the like. For additional security against blowing wind, four (or more) hooks on elastic cords (or the like), two (or more) at each end of the device may be used to hook under the front and rear bumpers of the vehicle (or the like).

When not in use, the device can be deflated and folded into a small compact size, making it portable and easily fit inside a vehicle's trunk, or the like. There are unique features of this device that make it more practical and more user-friendly than other products that seek to provide hail protection for a vehicle: (1) the design of the device and its attachment method allows a vehicle's occupants to deploy and use it whether they are inside or outside the vehicle, which gives the vehicle's occupants the option to remain inside the vehicle for personal protection during a hail storm (while other similar devices require the person deploying the device to stand outside the vehicle, and thus cannot offer the person protection from injury from hail); (2) during use, the design of the device still allows the vehicle's doors to open/close, thus allowing the occupants to enter/exit the vehicle; (3) there are multiple locations on the device where the attachment straps can go thru, allowing flexibility to use the device on different vehicle types/shapes (e.g. sedan vs SUV vs truck) (most users will attach one near the front windshield, one near the rear windshield, and one or two near the middle of the vehicle cabin near the B and C pillars); (4) the two separate layers allow for: a) quicker inflation time for just one layer to immediately provide hail protection; b) continued hail protection in the event that hail punctures one of the two layers; c) the owner to only inflate 1 layer if small hail is expected; and (5) quickly deploying anytime, anywhere because it can easily fit inside a vehicle's trunk.

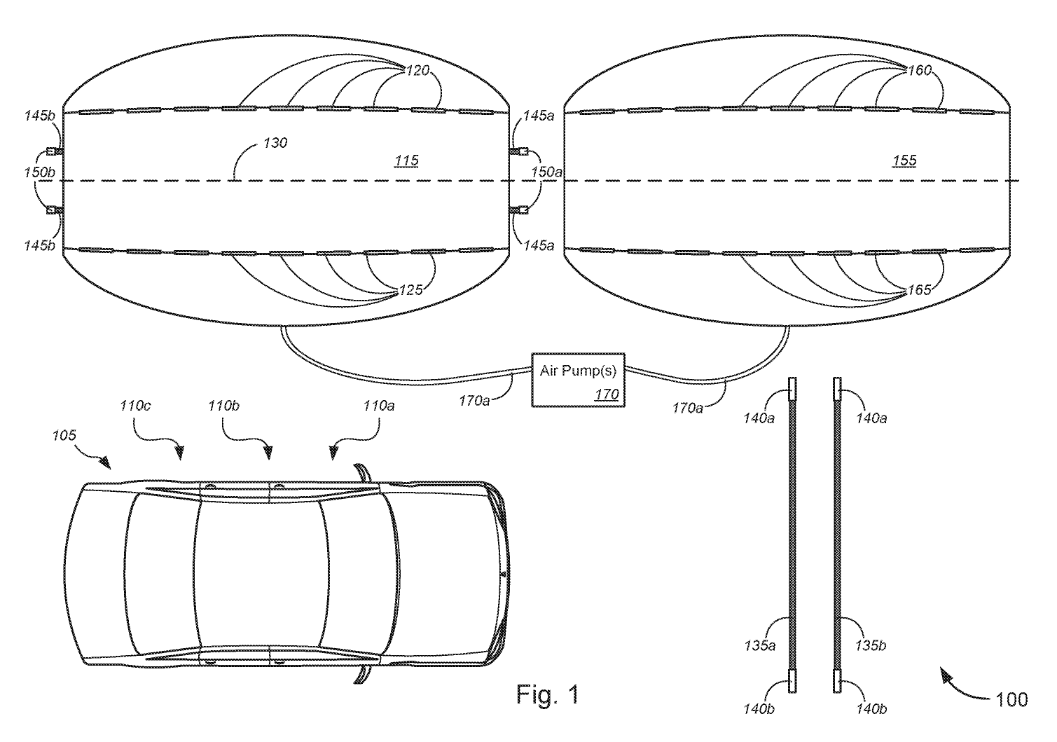

These and other functionalities of the system and device are described in detail below with respect to FIGS. 1-8.

The following detailed description illustrates a few exemplary embodiments in further detail to enable one of skill in the art to practice such embodiments. The described examples are provided for illustrative purposes and are not intended to limit the scope of the invention.

In the following description, for the purposes of explanation, numerous specific details are set forth in order to provide a thorough understanding of the described embodiments. It will be apparent to one skilled in the art, however, that other embodiments of the present invention may be practiced without some of these specific details. In other instances, certain structures and devices are shown in block diagram form. Several embodiments are described herein, and while various features are ascribed to different embodiments, it should be appreciated that the features described with respect to one embodiment may be incorporated with other embodiments as well. By the same token, however, no single feature or features of any described embodiment should be considered essential to every embodiment of the invention, as other embodiments of the invention may omit such features.

Unless otherwise indicated, all numbers used herein to express quantities, dimensions, and so forth used should be understood as being modified in all instances by the term “about.” In this application, the use of the singular includes the plural unless specifically stated otherwise, and use of the terms “and” and “or” means “and/or” unless otherwise indicated. Moreover, the use of the term “including,” as well as other forms, such as “includes” and “included,” should be considered non-exclusive. Also, terms such as “element” or “component” encompass both elements and components comprising one unit and elements and components that comprise more than one unit, unless specifically stated otherwise.

In an aspect, a vehicle hail protection system might comprise a first inflatable layer having a front end, a rear end, and sides; one or more straps; and at least one air pump, when operable, causing the first inflatable layer to be inflated. The first inflatable layer might comprise a plurality of first through-slots arrayed along at least a portion of a longitudinal length of the first inflatable layer extending from the front end to the rear end. When the first inflatable layer is disposed on a roof panel of a vehicle, the one or more straps might be disposed perpendicularly across the longitudinal length of the first inflatable layer, each strap being disposed through at least one of the plurality of first through-slots, wherein the one or more straps are engaged across the roof panel of the vehicle to secure the first inflatable layer to the roof panel of the vehicle.

In some embodiments, the at least one air pump might include, without limitation, a power plug configured to plug into one of a cigarette lighter socket, a universal serial bus (“USB”) port, or an electrical outlet (e.g., 100 V outlet, 110 V outlet, 120 V outlet, 220 V outlet, or 100-220 V outlet, etc.), and/or the like, wherein at least one of the cigarette lighter socket, the USB port, or the electrical outlet, and/or the like, might be disposed within the vehicle and power to the power plug might be supplied by a vehicle battery.

According to some embodiments, the vehicle hail protection system might further comprise a second inflatable layer, comprising a plurality of second through-slots arrayed along at least a portion of a longitudinal length of the second inflatable layer, wherein when the first inflatable layer and the second inflatable layer are disposed one layer over the other, the plurality of first through-slots are aligned with the plurality of second through-slots. Each of the one or more straps might be disposed through at least one first through-slot of the plurality of first through-slots and through at least one second through-slot of the plurality of second through-slots aligned with the at least one first through-slot, wherein the at least one first through-slot and the at least one second through-slot through which each strap is disposed are aligned with each other. In some cases, the at least one air pump might be disposed within at least one of the first inflatable layer or the second inflatable layer. Alternatively, the at least one air pump might be disposed external to each of at least one of the first inflatable layer or the second inflatable layer, wherein the at least one air pump might be disposed within the vehicle. In some instances, the second inflatable layer might comprise a material having a different durability or function compared with the material of the first inflatable layer.

In some embodiments, the first inflatable layer might comprise a top surface made of a material that is light-weight, airtight, and waterproof. In some cases, the material might comprise at least one of polyester fibers, nylon fibers, polypropylene fibers, polyethylene terephthalate (“PET”), biaxially-oriented polyethylene terephthalate (“BoPET”), polyvinyl chloride (“PVC”), urethane, rubber, laminate composites, Mylar®, Kevlar®, Conex®, Nomex®, Twaron®, Spectra®, Vectran®, cotton duck fabric, or cotton twill fabric, and/or the like. In some instances, the material might comprise a metal coating. In some cases, the material might be made of a material that protects against at least one of solar radiation, snow, or hail, and/or the like. Merely by way of example, in some instances, the first inflatable layer might have at least one of an ovoid shape, an elliptical shape, a rectangular shape, or other suitable geometric shape, and/or the like. Alternatively, or additionally, the first inflatable layer might have one of a convex or vehicle shape, or the like.

Merely by way of example, the plurality of first through-slots might be arranged in pairs symmetrically with respect to a central axis parallel with the longitudinal length of the first inflatable layer, wherein each of the one or more straps might be disposed through each pair of the at least one of the plurality of first through-slots. In some cases, the one or more straps engaging across the roof panel of the vehicle each might comprise a pair of coupling devices that, when engaged with each other, secures the first inflatable layer to the roof panel of the vehicle, wherein the pair of coupling devices might comprise one of a pair of complementary Velcro straps, a pair of complementary buckles, a pair of complementary clips, a set of ratchet strap and ratchet, a set of strap and plastic buckle, or a set of belt and buckle, and/or the like.

In some embodiments, the first inflatable layer might further comprise at least one front hook extending from the front end of the first inflatable layer and at least one rear hook extending from the rear end of the first inflatable layer, the at least one front hook configured to removably affix the first inflatable layer to a front portion of the vehicle, the at least one rear hook configured to removably affix the first inflatable layer to a rear portion of the vehicle. In some cases, each of one or more of the at least one front hook or the at least one rear hook might comprise a hook end and a connecting strap that connects the hook end to the first inflatable layer, wherein the hook end comprises one of a metal hook, a plastic hook, a carabiner clip, or a clamp, and/or the like, wherein the connecting strap might comprise one of an elastic cord; a set of ratchet strap and ratchet; a set of Velcro strap and loop with built-in hook connector; a set of strap, loop with built-in hook connector, and plastic buckle; or a set of belt, loop with built-in hook connector, and buckle; and/or the like.

According to some embodiments, the vehicle hail protection system might further comprise at least two side inflatable layers, each comprising a plurality of third through-slots arrayed along at least a portion of a longitudinal length of the side inflatable layer. When each of the at least two side inflatable layers are disposed along each side of the vehicle, one or more side straps might be disposed perpendicularly across the longitudinal length of each side inflatable layer, each side strap being disposed through at least one of the plurality of third through-slots, wherein the one or more side straps might be engaged across a door panel of the vehicle to secure each side inflatable layer to the sides of the vehicle, wherein one end of each side strap might couple to a chasis of the vehicle while the other end of each side strap might couple to one of the first inflatable layer or a strap of the one or more straps securing the first inflatable layer to the roof panel of the vehicle.

In another aspect, a method might comprise placing a first inflatable layer of a vehicle hail protection system on a roof panel of a vehicle, the first inflatable layer having a front end, a rear end, and sides, wherein the first inflatable layer might comprise a plurality of first through-slots arrayed along at least a portion of a longitudinal length of the first inflatable layer extending from the front end to the rear end; at least one front hook extending from the front end of the first inflatable layer; and at least one rear hook extending from the rear end of the first inflatable layer. The method might further comprise removably securing the at least one front hook to a front portion of the vehicle; removably securing the at least one rear hook to a rear portion of the vehicle; looping one or more straps of the vehicle hail protection system perpendicularly across the longitudinal length of the first inflatable layer, each strap being disposed through at least one of the plurality of first through-slots and being engaged across the roof panel of the vehicle to secure the first inflatable layer to the roof panel of the vehicle; and inflating the first inflatable layer using at least one air pump.

In some embodiments, the vehicle hail protection system might further comprise a second inflatable layer, comprising a plurality of second through-slots arrayed along at least a portion of a longitudinal length of the second inflatable layer, the method further comprising placing the second inflatable layer on the roof panel of the vehicle placed one on top of the other with respect to the first inflatable layer; wherein when the first inflatable layer and the second inflatable layer are disposed one layer over the other, the plurality of first through-slots are aligned with the plurality of second through-slots; wherein each of the one or more straps are disposed through at least one first through-slot of the plurality of first through-slots and through at least one second through-slot of the plurality of second through-slots aligned with the at least one first through-slot, wherein the at least one first through-slot and the at least one second through-slot through which each strap is disposed are aligned with each other. According to some embodiments, the at least one air pump might be disposed within at least one of the first inflatable layer or the second inflatable layer. Alternatively, the at least one air pump might be disposed external to each of at least one of the first inflatable layer or the second inflatable layer, wherein the at least one air pump might be disposed within the vehicle.

According to some embodiments, the at least one air pump might comprise a power plug configured to plug into one of a cigarette lighter socket, a universal serial bus (“USB”) port, or an electrical outlet (e.g., 100 V outlet, 110 V outlet, 120 V outlet, 220 V outlet, or 100-220 V outlet, etc.), and/or the like, wherein at least one of the cigarette lighter socket, the USB port, or the electrical outlet, and/or the like might be disposed within the vehicle and power to the power plug might be supplied by a vehicle battery. The plurality of first through-slots might be arranged in pairs symmetrically with respect to a central axis parallel with the longitudinal length of the first inflatable layer, wherein each of the one or more straps are disposed through each pair of the at least one of the plurality of first through-slots. The one or more straps engaging across the roof panel of the vehicle might each comprise a pair of coupling devices that, when engaged with each other, secures the first inflatable layer to the roof panel of the vehicle, wherein the pair of coupling devices might comprise one of a pair of complementary Velcro straps, a pair of complementary buckles, a pair of complementary clips, a set of ratchet strap and ratchet, a set of strap and plastic buckle, or a set of belt and buckle, and/or the like.

In some embodiments, each of one or more of the at least one front hook or the at least one rear hook might comprise a hook end and a connecting strap that connects the hook end to the first inflatable layer, wherein the hook end might comprise one of a metal hook, a plastic hook, a carabiner clip, or a clamp, and/or the like, wherein the connecting strap might comprise one of an elastic cord; a set of ratchet strap and ratchet; a set of Velcro strap and loop with built-in hook connector; a set of strap, loop with built-in hook connector, and plastic buckle; or a set of belt, loop with built-in hook connector, and buckle; and/or the like. In some cases, the removably securing the at least one front hook to a front portion of the vehicle might comprise removably securing the at least one front hook to one of a front bumper, at least one tow hook, or a chassis of the vehicle, and/or the like, wherein removably securing the at least one rear hook to a rear portion of the vehicle might comprise removably securing the at least one rear hook to one of a rear bumper, at least one tow hook, or the chassis of the vehicle, and/or the like.

According to some embodiments, looping the one or more straps might comprise looping the one or more straps near at least one of an A pillar, a B pillar, a C pillar, or a D pillar of the vehicle, and/or the like. In some cases, the first inflatable layer might comprise a top surface made of a material that is light-weight, airtight, and waterproof. Merely by way of example, in some instances, the material might comprise at least one of polyester fibers, nylon fibers, polypropylene fibers, polyethylene terephthalate (“PET”), biaxially-oriented polyethylene terephthalate (“BoPET”), polyvinyl chloride (“PVC”), urethane, rubber, laminate composites, Mylar®, Kevlar®, Conex®, Nomex®, Twaron®, Spectra®, Vectran®, cotton duck fabric, or cotton twill fabric, and/or the like. In some instances, the first inflatable layer has at least one of an ovoid shape, an elliptical shape, or a rectangular shape, and/or the like. In some cases, the first inflatable layer might have one of a convex or vehicle shape, or the like.

Various modifications and additions can be made to the embodiments discussed without departing from the scope of the invention. For example, while the embodiments described above refer to particular features, the scope of this invention also includes embodiments having different combination of features and embodiments that do not include all of the above described features.

### Specific Exemplary Embodiments

We now turn to the embodiments as illustrated by the drawings. FIGS. 1-8 illustrate some of the features of the method, system, and apparatus for implementing hail protection, and, more particularly, to methods, systems, and apparatuses for implementing vehicle and personal hail protection, as referred to above. The methods, systems, and apparatuses illustrated by FIGS. 1-8 refer to examples of different embodiments that include various components and steps, which can be considered alternatives or which can be used in conjunction with one another in the various embodiments. The description of the illustrated methods, systems, and apparatuses shown in FIGS. 1-8 is provided for purposes of illustration and should not be considered to limit the scope of the different embodiments.

With reference to the figures, FIG. 1 is a schematic diagram illustrating a system 100 for implementing vehicle and personal hail protection, in accordance with various embodiments. As shown in FIG. 1, a vehicle 105 might comprise an A-pillar 110a, a B-pillar 110b, a C-pillar 110c, and/or the like (collectively, “vehicle pillars” or the like; longer vehicles having more pillars (e.g., D-pillar, E-pillar, etc.)), as understood by those skilled in the art.

In the non-limiting embodiment of FIG. 1, system 100 might comprise a first inflatable layer 115 having a front end, a rear end, and sides. In some cases, the front end and the rear end might be similar, if not identical, so that either end can (interchangeably) be removably attached to a front or rear of vehicle 105. Alternatively, for first inflatable layers 115 that are configured to have a general vehicle shape (so as to more closely mold to the shape of the vehicle) (not shown), the front end and the rear end are clearly identifiable for vehicles other than a sedan or the like (i.e., pick-up trucks, SUVs, cross-over SUVs, hatch-back vehicles, etc.). The first inflatable layer 115 might include, without limitation, a plurality of first through-slots (i.e., slots 120 and/or 125) arrayed along at least a portion of a longitudinal length of the first inflatable layer 115 extending from the front end to the rear end. In some embodiments, the plurality of first through-slots are arranged in pairs (120, 125) symmetrically with respect to a central axis 130 parallel with the longitudinal length of the first inflatable layer 115. Although eighteen (18) slots 120 and 125 are shown in FIG. 1, the various embodiments are not so limited, and the first inflatable layer 115 can have any suitable number of slots 120 and/or 125. Also, although the slots 120 and 125 are shown in FIG. 1 as being arranged along a slight curved line that bulges from a middle of the central axis 130 (with respect to the front and rear ends of the first inflatable layer 115), the various embodiments are not so limited, and the slots 120 and 125 may be arranged in any suitable configuration (e.g., parallel with the central axis 130, along a curved line that bends inward toward the middle of the central axis 130 (with respect to the front and rear ends of the first inflatable layer 115), along an S-curve extending from the front end to the rear end, along multiple consecutive or contiguous S-curves extending from the front end to the rear end, or along some other curved line extending from the front end to the rear end, along three or more curved or parallel lines extending from the front end to the rear end, and/or the like). According to some embodiments, the slots 120 and 125 may have any suitable length, width, or shape, and/or the like. In some cases, each of the slots 120 and 125 may be embodied as slots similar to button holes whose side edges might overlap each other, reduce the opening of the slots between the side edges, or touch each other along portions of the side edges, or the like (not shown) when the straps are not fitted through them. In this manner, the holes or slots 120 and 125 may be minimized when not in use.

System 100 might further comprise one or more straps 135a, 135b, etc. (collectively, “straps 135” or the like). Each strap 135 might comprise a pair of coupling devices 140a, 140b, etc. (collectively, “coupling devices 140” or the like) that, when engaged with each other, secures the first inflatable layer 115 to a roof panel of the vehicle 105. In some cases, the pair of coupling devices 140 might include, without limitation, one of a pair of complementary Velcro straps, a pair of complementary buckles, a pair of complementary clips, a set of ratchet strap and ratchet, a set of strap and plastic buckle, or a set of belt and buckle, and/or the like.

The first inflatable layer 115 might further include, without limitation, at least one front hook 150a extending from the front end of the first inflatable layer 115 via a corresponding at least one connecting strap 145a and at least one rear hook 150b extending from the rear end of the first inflatable layer 115 via a corresponding at least one connecting strap 145b. The at least one front hook 150a is configured to removably secure or affix the first inflatable layer 115 to a front portion of the vehicle 105, while the at least one rear hook 150b is configured to removably secure or affix the first inflatable layer 115 to a rear portion of the vehicle 105. In some embodiments, each of one or more of the at least one front hook or the at least one rear hook might include, but is not limited to, a hook end and a connecting strap that connects the hook end to the first inflatable layer. The hook end, in some cases, might include, without limitation, one of a metal hook, a plastic hook, a carabiner clip, or a clamp, and/or the like. The connecting strap, might include, but is not limited to, one of an elastic cord; a set of ratchet strap and ratchet; a set of Velcro strap and loop with built-in hook connector; a set of strap, loop with built-in hook connector, and plastic buckle; or a set of belt, loop with built-in hook connector, and buckle, and/or the like. According to some embodiments, removably securing or affixing the at least one front hook to a front portion of the vehicle might comprise removably securing or affixing the at least one front hook to one of a front bumper, at least one tow hook, or a chassis of the vehicle, and/or the like, while removably securing or affixing the at least one rear hook to a rear portion of the vehicle might comprise removably securing or affixing the at least one rear hook to one of a rear bumper, at least one tow hook, or the chassis of the vehicle, and/or the like.

In some embodiments, system 100 might further comprise a second inflatable layer 155, which might include, without limitation, a plurality of second through-slots (i.e., slots 160 and/or 165) arrayed along at least a portion of a longitudinal length of the second inflatable layer 155 (extending from a front end to a rear end thereof, not unlike the first inflatable layer 115). In some cases, the plurality of second through-slots (i.e., slots 160 and/or 165) might be similar, if not identical, to the plurality of first through-slots (i.e., slots 120 and/or 125). According to some embodiments, the plurality of second through-slots are arranged in pairs (160, 165) symmetrically with respect to a central axis 130 parallel with the longitudinal length of the second inflatable layer 155. Although eighteen (18) slots 160 and 165 are shown in FIG. 1, the various embodiments are not so limited, and the second inflatable layer 155 can have any suitable number of slots 160 and/or 165. Also, although the slots 160 and 165 are shown in FIG. 1 as being arranged along a curved line that bulges from a middle of the central axis 130 (with respect to the front and rear ends of the second inflatable layer 155), the various embodiments are not so limited, and the slots 160 and 165 may be arranged in any suitable configuration (e.g., parallel with the central axis 130, along a curved line that bends inward toward the middle of the central axis 130 (with respect to the front and rear ends of the second inflatable layer 155), along an S-curve extending from the front end to the rear end, along multiple consecutive or contiguous S-curves extending from the front end to the rear end, or along some other curved line extending from the front end to the rear end, along three or more curved or parallel lines extending from the front end to the rear end, and/or the like). The first inflatable layer 115 and the second inflatable layer 155 are configured to be disposed one layer over the other, with the plurality of first through-slots 120 and/or 125 being aligned with the plurality of second through-slots 160 and/or 165, when disposed over a vehicle. In some cases, the first inflatable layer 115 might be disposed over the second inflatable layer 155. Alternatively, the second inflatable layer 155 might be disposed over the first inflatable layer 115. In some instances, only one of the first inflatable layer 115 or the second inflatable layer 155 might have the at least one front hook and the at least one rear hook integrated therewith, while the other of the first inflatable layer 115 or the second inflatable layer 155 might have no front or rear hooks, as shown in FIG. 1. Alternatively, each inflatable layer might have a set of the at least one front hook and the at least one rear hook. In such cases, one set of the at least one front hook and the at least one rear hook might be used to removably secure or affix one of the inflatable layers to the front and rear of the vehicle, while the other set(s) of the at least one front hook and the at least one rear hook might be either stowed away, removably secured to the set that is actually securing or affixing the inflatable layer the vehicle, or used to removably secure or affix the other(s) of the inflatable layers to other parts of the front and rear of the vehicle. In some embodiments, the multiple inflatable layers might be integrated into a single unit with multiple layers or compartments.

Although the figures depict only two inflatable layers 115 and 155, the various embodiments are not so limited, and the system might comprise three or more inflatable layers being used, with each inflatable layer being disposed one over the other. In such embodiments, the slots on one inflatable layer might align with slots on each of the other inflatable layers. In some cases, the materials of each inflatable layer might be identical, with each successive layer provide an extra layer of protection against hail or other impacts. Alternatively, the materials of each inflatable layer might be different, each inflatable layer having material designed or configured for particular purposes. For example, for light rain, the top-most inflatable layer might be made of a material that is a lower durability, light weight, waterproof material. For heavy rain protection, the top-most inflatable layer might be made of a material that is a medium durability, medium weight, waterproof material. For medium to large hail or for medium to heavy snow, the top-most inflatable layer might be made of a material that is a higher durability, heavier weight, waterproof material. For sun protection, the top-most inflatable layer might be made of a material that is a lower durability, light weight, UV-resistant material (that need not be waterproof, but can be). And so on. In each case, the material of each inflatable layer is airtight to allow the inflatable layer to be inflated and to remain inflated with air or other gases. Alternatively, the system might comprise a single inflatable layer (e.g., layer 115 or the like).

Merely by way of example, the material for each of the inflatable layers might include, without limitation, at least one of polyester fibers, nylon fibers, polypropylene fibers, polyethylene terephthalate (“PET”), biaxially-oriented polyethylene terephthalate (“BoPET”), polyvinyl chloride (“PVC”), urethane, rubber, laminate composites, Mylar®, Kevlar®, Conex®, Nomex®, Twaron®, Spectra®, Vectran®, cotton duck fabric, or cotton twill fabric, and/or the like. The material might be further treated or coated with metal, plastic coatings, resins, and/or the like, in order to enhance any one or more of durability, water-tightness, air-tightness, UV resistance, puncture resistance, water resistance, and/or the like.

System 100 might further comprise one or more air pumps 170, which might comprise a power plug configured to plug into one of a cigarette lighter socket, a universal serial bus (“USB”) port, or an electrical outlet (e.g., 100 V outlet, 110 V outlet, 120 V outlet, 220 V outlet, or 100-220 V outlet, etc.), and/or the like, where at least one of the cigarette lighter socket, the USB port, or the electrical outlet might be disposed within the vehicle and power to the power plug might be supplied by a vehicle battery. Alternatively, or additionally, one or more of the USB port or the electrical outlet might be disposed outside the vehicle (e.g., on a wall outlet or data port of a building, on a port of a portable generator, a solar generator, and/or the like), and power to the power plug might be supplied by one of electrical grid power through a building, by power from the portable generator, by power from the solar generator, and/or the like. According to some embodiments, the at least one air pump might be disposed within at least one of the first inflatable layer 115 or the second inflatable layer 155 (or other inflatable layer), or the like. In some embodiments, each inflatable layer might have a built-in air pump 170. In such cases, each built-in air pump 170 might be individually connected to a power supply. Alternatively, each built-in air pump 170 might further comprise daisy-chaining connectors so that one air pump 170 in one inflatable layer connects to another air pump 170 in another inflatable layer, and so on, and eventually connects to the power supply. Alternatively, the at least one air pump might be disposed external to each of at least one of the first inflatable layer or the second inflatable layer, where the at least one air pump is disposed within the vehicle 105. For external air pumps 170, air hoses 170a might be used to supply air from the air pump(s) 170 to the inflatable layer(s) 115, 155, or the like. In such cases, one external air pump 170 might be used to supply air to multiple (if not all) connected inflatable layers, either through daisy-chaining air connectors (and valves) or through multiple air hoses 170a connected in parallel between the external air pump 170 and each of the multiple, connected inflatable layers. According to some embodiments, alternative or additional to use of a power plug to power the one or more air pumps 170, the one or more air pumps might (further) comprise at least one of one or more batteries, one or more solar cells, one or more other power generators, and/or the like, to supply power to the one or more air pumps 170 to inflate the inflatable layer(s) 115 and/or 155.

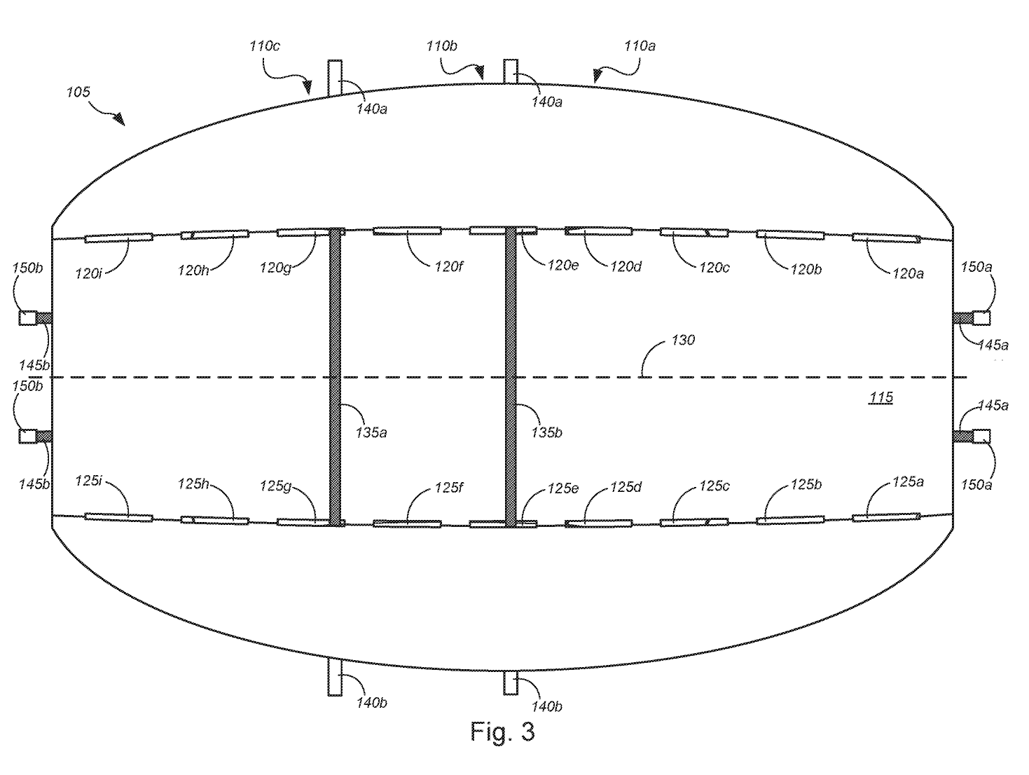

In operation, the first inflatable layer 115 and the second inflatable layer 155 (and any other inflatable layers) might be stacked one on top of the other. The straps 135a and 135b might be looped perpendicularly across the longitudinal length of the inflatable layers, each strap being disposed through the at least one slot of each layer (e.g., through one pair of slots 120 and 125, through corresponding pair of slots 160 and 165, by first looping through slot 120 or slot 160 (or corresponding slot in each additional inflatable layer), then through (corresponding slot in each additional inflatable layer or) slot 165 or slot 125, or vice versa, etc.). FIG. 3 depicts two straps 135a and 135b being looped through different pairs of slots 120 and 125 of the first inflatable layer 115, which is configured to be disposed over vehicle 105. In particular, strap 135a is shown being looped through slots 125g and 120g of the first inflatable layer 115, while strap 135b is shown being looped through slots 125e and 120e of the first inflatable layer 115. Although not shown, straps 135a and 135b might also be looped through corresponding pairs of one or more other inflatable layers (e.g., second inflatable layer 155 and/or other inflatable layers, or the like) underneath the first inflatable layer 115 (i.e., between the first inflatable layer 115 and vehicle 105). Although two straps 135 are shown being looped through two different pairs of slots 120 and 125, any number of straps 135 may be looped through the corresponding number of pairs of slots 120 and 125, or the like (e.g., in the case of longer vehicles requiring protection from hail, snow, rain, sun, or the like).

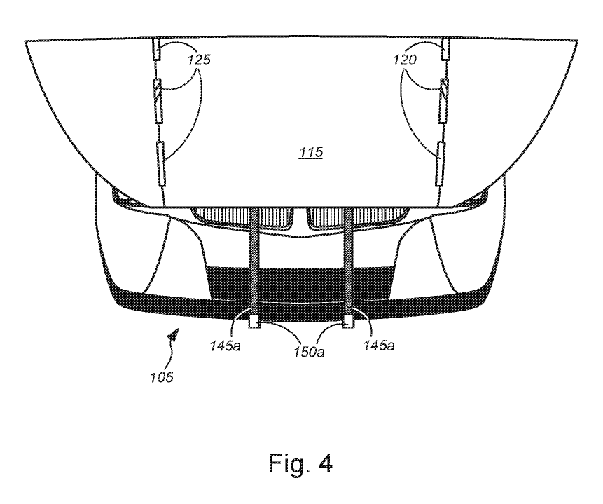

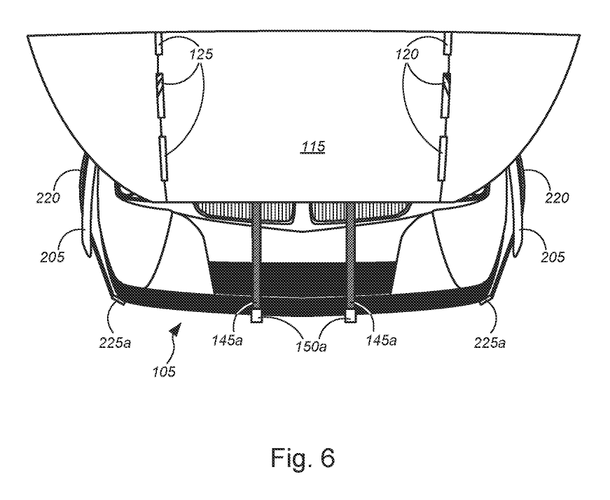

After the straps 135 have been looped through the slots of one or more inflatable layers 115, 155, and/or the like, the one or more inflatable layers may be placed on the roof panel of the vehicle 105, and the at least one front hook may be removably secured, affixed, or attached to a front portion(s) of the vehicle 105 (i.e., to the front bumper, to one or more front tow hooks, or to the chassis under or behind the front bumper, or the like), as generally depicted in FIGS. 4 and 6, for instance. Likewise, the at least one rear hook may be removably secured, affixed, or attached to a rear portion(s) of the vehicle 105 (i.e., to the rear bumper, to one or more rear tow hooks, or to the chassis under or in front of the rear bumper, or the like) (not shown). After or before the at least one front hook or the at least one rear hook is removably secured, affixed, or attached to the front or rear portion(s) of the vehicle 105, respectively, the straps 135 may be looped through the windows of the vehicle 105 near one or more of the B-pillar 110b, the C-pillar 110c, and/or the like, so that the pair of coupling devices 140a and 140b of each strap 135 can removably couple to each other, such that each of the straps 135 wraps around the roof panel of the vehicle 105 while pinning the one or more inflatable layers to the top surface of the roof panel of the vehicle 105.

Once the one or more inflatable layers are secured to the vehicle 105 (i.e., once the straps 135 have lashed the one or more inflatable layers to the roof panel of the vehicle 105, e.g., near one or more pillars 110 of the vehicle 105, and once the at least one front hook and the at least one rear hook have been removably secured to the front and rear portions of the vehicle 105, respectively), the at least one air pump 170 may be used to inflate at least one (if not all) of the one or more inflatable layers that are secured to the vehicle 105, thereby providing the vehicle 105 with protection against hail, snow, rain, or sun, and/or the like, depending on which inflatable layers are used.

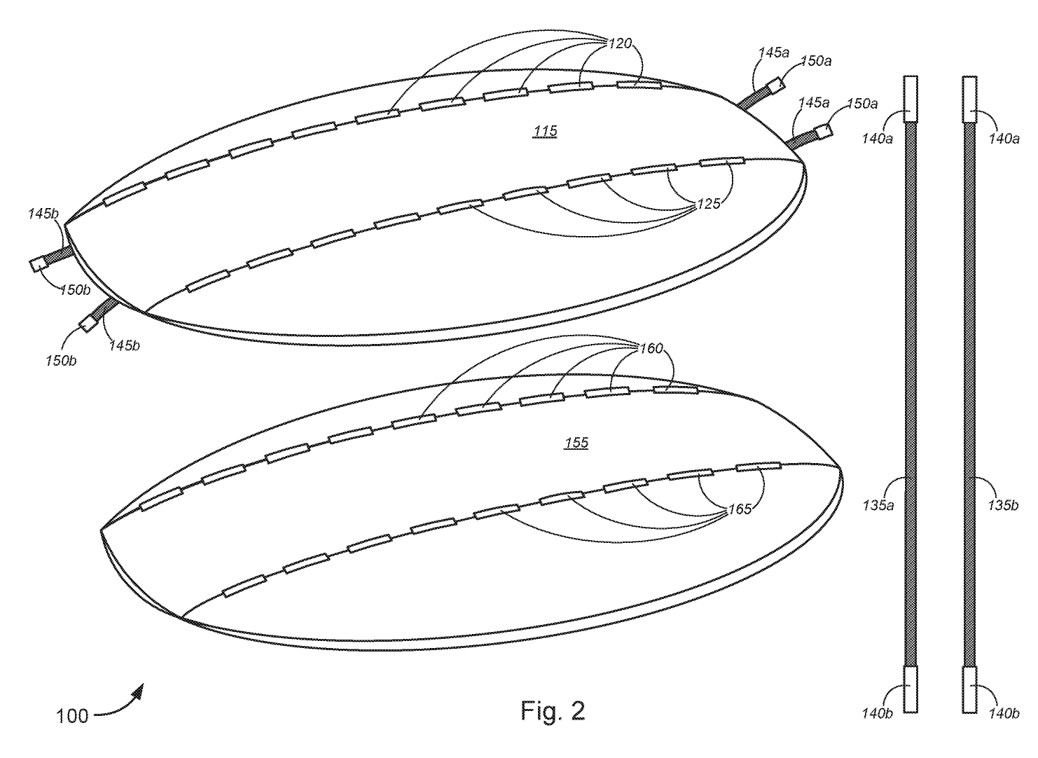

According to some embodiments, the inflatable layers 115 and 155, the straps 135, and/or the like may be of any suitable size. In some cases, the inflatable layers 115 and 155 might be sized such that the middle portions of the inflatable layers between the two sets of slots 120 and 125 (or slots 160 and 165) might cover the width of the roof of the vehicle 105, while the side portions of the inflatable layers beyond each of the two sets of slots 120 and 125 (or slots 160 and 165) (i.e., extending from the slots 120, 125, 160, or 165 to the side edges of the inflatable layers 115 or 155, or the like) might extend beyond or might hang over the roof of the vehicle 105, and might press against the sides of the vehicle 105 due to wind or hail, or the like to protect at least the top portion of the sides of the vehicle 105. The size of each of the various components and/or features of system 100 as depicted in FIG. 1 (or in any of FIGS. 2-7) is thus merely illustrative and non-limiting to the various embodiments.

In some aspects, a device can provide protection for a vehicle and its occupants during a hailstorm by minimizing the damaging effects of falling hailstone. The device might be generally ovoid or elliptical and convex in shape, comprising two (or more) distinct airtight compartments (or layers) that can each inflate separately. The device might be fabricated from a relatively light, airtight, and waterproof material. When protection from hailstone is needed, the device can be quickly placed over the top of the vehicle, secured, then inflated with an air pump that plugs into a vehicle's cigarette lighter socket, USB port, or electrical outlet (e.g., 100 V outlet, 110 V outlet, 120 V outlet, 220 V outlet, or 100-220 V outlet, etc.), or the like. Once inflated, the device is ready to provide an air-cushion barrier against falling hailstone. The device may be attached to a vehicle utilizing three or four straps (only two are shown in the figures). For most vehicles, one strap is placed along the front window, one or two straps close to the B and/or C pillars, and one along the back window. Once the device is placed on top of the vehicle, each strap wraps around the top of the device and the ends are brought together inside the vehicle. The two ends of each strap are secured to each other by Velcro, buckles, clips, strap and ratchet device, strap and buckle device, belt and buckle device, and/or the like. For additional security against blowing wind, four (or more) hooks on elastic cords (or the like), two (or more) at each end of the device may be used to hook under the front and rear bumpers of the vehicle (or the like).

When not in use, the device can be deflated and folded into a small compact size, making it portable and easily fit inside a vehicle's trunk, or the like. There are unique features of this device that make it more practical and more user-friendly than other products that seek to provide hail protection for a vehicle: (1) the design of the device and its attachment method allows a vehicle's occupants to deploy and use it whether they are inside or outside the vehicle, which gives the vehicle's occupants the option to remain inside the vehicle for personal protection during a hail storm (while other similar devices require the person deploying the device to stand outside the vehicle, and thus cannot offer the person protection from hail); (2) during use, the design of the device still allows the vehicle's doors to open/close, thus allowing the occupants to enter/exit the vehicle; (3) there are multiple locations on the device where the attachment straps can go thru, allowing flexibility to use the device on different vehicle types/shapes (e.g. sedan vs SUV vs truck) (most users will attach one near the front windshield, one near the rear windshield, and one or two near the middle of the vehicle cabin near the B and C pillars); (4) the two separate layers allow for: a) quicker inflation time for just one layer to immediately provide hail protection; b) continued hail protection in the event that hail punctures one of the two layers; c) the owner to only inflate 1 layer if small hail is expected; and (5) quickly deploying anytime, anywhere because it can easily fit inside a vehicle's trunk.

FIG. 2 is a schematic diagram illustrating a perspective view of the system 100 of FIG. 1 for implementing vehicle and personal hail protection. In the non-limiting embodiment of FIG. 2, the first inflatable layer 115 and the second inflatable layer 155 are shown in perspective view, with the first inflatable layer 115 being disposed above the second inflatable layer 155. In FIG. 2, the first inflatable layer 115 and the second inflatable layer 155 are depicted as being ovoid or elliptical in shape (i.e., as having an ovoid or elliptical shape, or the like). Alternatively, although not shown, the first inflatable layer 115 and the second inflatable layer 155 might have a rectangular shape, or the like. The first inflatable layer 115 and the second inflatable layer 115 are also depicted in FIG. 2 having a generally convex shape. Alternatively, the first inflatable layer 115 and the second inflatable layer 115 might have either a general vehicle shape or a specific vehicle shape. In other words, the first inflatable layer 115 and the second inflatable layer 115 might each be shaped on the underside to more closely fit most sedans, to more closely fit most pickup trucks, to more closely fit most mini-SUVs, to more closely fit most mid-sized SUVs, to more closely fit most full-sized SUVs, to more closely fit most cross-over SUVs, to more closely fit most mini-vans, or the like. In some embodiments, constricting straps (not shown) on the underside of one or more of the inflatable layers might be used to adjustably conform the one or more inflatable layers to more closely fit a wider variety of these classes of vehicles. According to some embodiments, not all of the inflatable layers are required to have such constricting straps (not shown), only the top-most layer need have such constricting straps.

The first inflatable layer 115 (and slots 120 and 125), the at least one front hook 150a (and connecting strap(s) 145a), the at least one rear hook 150b (and connecting strap(s) 145b), the second inflatable layer 155 (and slots 160 and 165), the straps 135a and 135b (and coupling devices 140a and 140b) of FIG. 2 are otherwise similar, if not identical, to the first inflatable layer 115 (and slots 120 and 125), the at least one front hook 150a (and connecting strap(s) 145a), the at least one rear hook 150b (and connecting strap(s) 145b), the second inflatable layer 155 (and slots 160 and 165), the straps 135a and 135b (and coupling devices 140a and 140b) of FIG. 1, respectively, and the description of these components of FIG. 1 are otherwise applicable to the corresponding components of FIG. 2.

FIG. 3 is a schematic diagram illustrating a top view of the system 100 of FIG. 1 for implementing vehicle and personal hail protection as placed over a vehicle. As described above, FIG. 3 depicts at least the first inflatable layer 115 being disposed over (and in some cases, directly or indirectly on) the vehicle 105. In the non-limiting embodiment of FIG. 3, the first inflatable layer 115 comprises slots 120a-120i (collectively, “slots 120”) that are each paired with, and each symmetric about center line 130 with respect to, slots 125a-125i (collectively, “slots 125”). As slot pair 120e and 125e is located near the B-pillar 110b of the vehicle 105 when the first inflatable layer 115 is placed over vehicle 105, one of the straps 135b might be looped through slots 120e and 125e, and subsequently (although not shown) looped through either the front windows or the back windows near the B-pillar 110b such that the coupling devices 140a and 140b can be coupled together under the roof panel of the vehicle 105. Similarly, as slot pair 120g and 125g is located near the C-pillar 110c of the vehicle 105 when the first inflatable layer 115 is placed over vehicle 105, another of the straps 135a might be looped through slots 120g and 125g, and subsequently (although not shown) looped through the back windows near the C-pillar 110c such that the coupling devices 140a and 140b can be coupled together under the roof panel of the vehicle 105. For longer vehicles, more straps might be looped through other pairs of slots and through windows or other openings near other pillars 110 (not shown) of the vehicle to further secure the first inflatable layer 115 (and any other inflatable layers (not specifically shown)) over or on the vehicle 105.

The at least one front hook 150a (which may be connected to the first inflatable layer 115 by connecting strap(s) 145a) may be removably secured, affixed, or attached to a front portion(s) of the vehicle 105 (i.e., to the front bumper, to one or more front tow hooks, or to the chassis under or behind the front bumper, or the like) (not shown in FIG. 3). Likewise, the at least one rear hook 150b (which may be connected to the first inflatable layer 115 by connecting strap(s) 145b) may be removably secured, affixed, or attached to a rear portion(s) of the vehicle 105 (i.e., to the rear bumper, to one or more rear tow hooks, or to the chassis under or in front of the rear bumper, or the like) (not shown).

The vehicle 105, the first inflatable layer 115 (and slots 120 and 125), the at least one front hook 150a (and connecting strap(s) 145a), the at least one rear hook 150b (and connecting strap(s) 145b), the straps 135a and 135b (and coupling devices 140a and 140b) of FIG. 3 are otherwise similar, if not identical, to the vehicle 105, the first inflatable layer 115 (and slots 120 and 125), the at least one front hook 150a (and connecting strap(s) 145a), the at least one rear hook 150b (and connecting strap(s) 145b), the straps 135a and 135b (and coupling devices 140a and 140b) of FIG. 1, respectively, and the description of these components of FIG. 1 are otherwise applicable to the corresponding components of FIG. 3.

FIG. 4 is a schematic diagram illustrating a front elevation view of the system 100 of FIG. 3 for implementing vehicle and personal hail protection as placed over a vehicle. In the non-limiting embodiment of FIG. 4, the first inflatable layer 115 (with slots 120 and 125) is depicted as being removably secured, attached, and/or affixed to at least one front portion of vehicle 105 via at least one front hook 150a (each of which is connected to the first inflatable layer 115 via connecting straps 145a). Although not shown, at least one rear hook 150b (each of which is also connected to the first inflatable layer 115 via connecting straps 145b) may also be used to removably secure, attach, and/or affix the first inflatable layer 115 to at least one rear portion of vehicle 105.

The first inflatable layer 115 (and slots 120 and 125) and the at least one front hook 150a (and connecting strap(s) 145a) of FIG. 4 are otherwise similar, if not identical, to the first inflatable layer 115 (and slots 120 and 125) and the at least one front hook 150a (and connecting strap(s) 145a), respectively, of FIG. 3, and the description of these components of FIG. 3 are otherwise applicable to the corresponding components of FIG. 4.

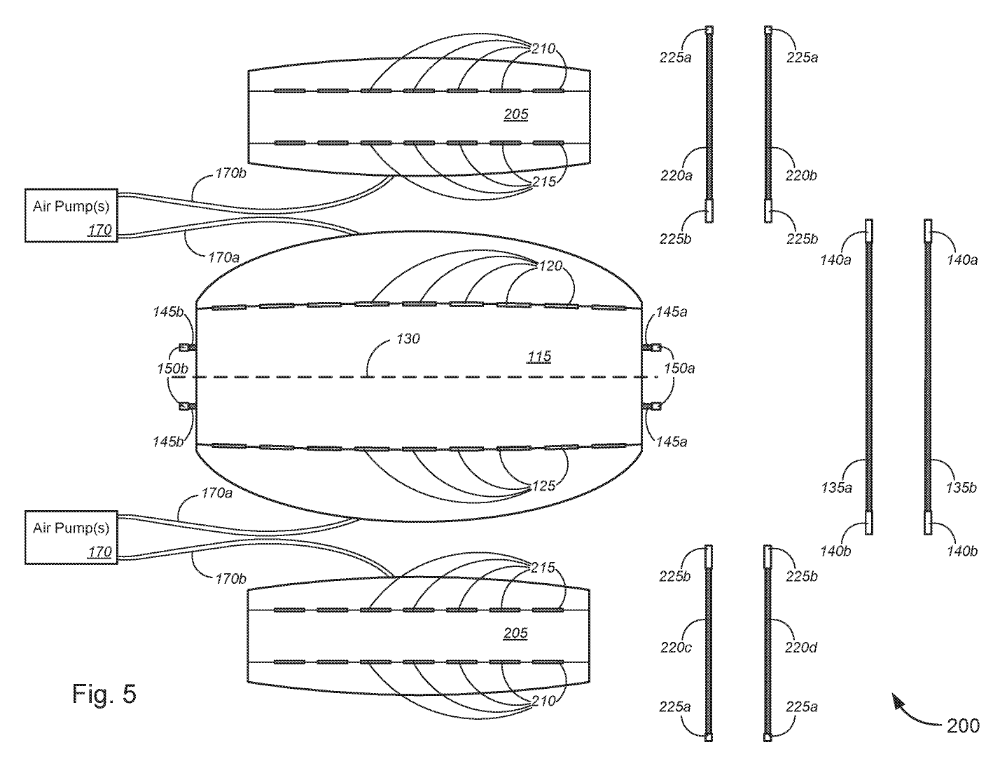

FIG. 5 is a schematic diagram illustrating another embodiment 200 of a system for implementing vehicle and personal hail protection. In the non-limiting embodiment of FIG. 5, system 200 might comprise the first inflatable layer 115 (which comprises a plurality of slots 120 and 125, at least one front hook 150a, at least one rear hook 150b, connecting straps 145a and 145b, and/or the like) and straps 135a and 135b (with coupling devices 140a and 140b), as described above with respect to FIGS. 1-4. Although not shown, system 200 might further comprise any number of other inflatable layers (e.g., second inflatable layer 155, or other inflatable layers, or the like), as described in detail above with respect to FIGS. 1-4.

As further shown in FIG. 5, system 200 might further comprise side inflatable layers 205 (one for each side of the vehicle 105 of FIG. 1, or the like). Each side inflatable layer 205 might comprise a plurality of slots (e.g., slots 210 and 215), which might be similarly arrayed compared with slots 120 and 125 of the first inflatable layer 115, or the like. One or more side straps 220a-220d (each with corresponding coupling devices 225a and 225b) may be used to removably secure, attach, or affix each side inflatable layer 205 to the corresponding side of the vehicle (e.g., vehicle 105 or the like), e.g., as shown in the non-limiting embodiment of FIG. 6. In particular, at least one top hook 225b of each side strap 220 might be removably secured, attached, or affixed to one of a roof panel of the vehicle, one of the plurality of first (and/or second) through-slots 120 and 125 (or 160 and 165 of the second inflatable layer 155 (not shown), or the like), or one of the one or more straps 135, and/or the like. Similarly, at least one bottom hook 225a of each side strap 220 might be removably secured, attached, or affixed to the chassis of the vehicle.

Once the inflatable layer(s) 115 (or the like) and the side inflatable layers 205 have been removably secured, attached, or affixed to the vehicle, at least one air pump 170 might be used to inflate the inflatable layer(s) 115 (or the like) and the side inflatable layers 205 via air hoses 170a and 170b (for external air pumps 170). For built-in air pumps 170, power cables might extend outside the inflatable layer or the side inflatable layer in which the air pump 170 is disposed, to electrically couple to a power supply (e.g., one of a cigarette lighter socket, a universal serial bus (“USB”) port, or an electrical outlet (e.g., 100 V outlet, 110 V outlet, 120 V outlet, 220 V outlet, or 100-220 V outlet, etc.), and/or the like, which may or may not be located in the vehicle). Daisy-chaining of the power cables and/or the air hoses 170a (or 170b) might be performed, as described above with respect to FIG. 1, or the like. According to some embodiments, alternative or additional to use of a power cables that connect to electrical outlets to power the one or more air pumps 170, the one or more air pumps might (further) comprise at least one of one or more batteries, one or more solar cells, one or more other power generators, and/or the like, to supply power to the one or more air pumps 170 to inflate the inflatable layer(s) 115 and/or 205.

The side inflatable layers 205 (and slots 210 and 215) and the side straps 220 (and hooks 225a and 225b) are otherwise similar, if not identical, to the first inflatable layer 115 (and slots 120 and 125) or the second inflatable layer 155 (and slots 160 and 165) and the straps 135 (and hooks 140a and 140b) of FIGS. 1-4, and the description of these components are otherwise applicable to the side inflatable layers 205 (and slots 210 and 215) and the side straps 220 (and hooks 225a and 225b).

The first inflatable layer 115 (and slots 120 and 125), the at least one front hook 150a (and connecting strap(s) 145a), the at least one rear hook 150b (and connecting strap(s) 145b), the straps 135a and 135b (and coupling devices 140a and 140b) of FIG. 5 are otherwise similar, if not identical, to the first inflatable layer 115 (and slots 120 and 125), the at least one front hook 150a (and connecting strap(s) 145a), the at least one rear hook 150b (and connecting strap(s) 145b), the straps 135a and 135b (and coupling devices 140a and 140b), respectively, of FIGS. 1-4, and the description of these components of FIGS. 1-4 are otherwise applicable to the corresponding components of FIG. 5.

FIG. 6 is a schematic diagram illustrating a front elevation view of the system 200 of FIG. 5 for implementing vehicle and personal hail protection as placed over a vehicle. In the non-limiting embodiment of FIG. 6, the first inflatable layer 115 (with slots 120 and 125) is depicted as being removably secured, attached, and/or affixed to at least one front portion of vehicle 105 via at least one front hook 150a (each of which is connected to the first inflatable layer 115 via connecting straps 145a). Although not shown, at least one rear hook 150b (each of which is also connected to the first inflatable layer 115 via connecting straps 145b) may also be used to removably secure, attach, and/or affix the first inflatable layer 115 to at least one rear portion of vehicle 105. In the non-limiting embodiment of FIG. 6, the side inflatable layers 205 are also depicted as being removably secured, attached, and/or affixed to the chassis of the vehicle 105 via at least one bottom hook 225a (each of which is connect to the corresponding side strap 220, which loops through slots in the side inflatable layers 205 to secure the side inflatable layers 205 to the side of the vehicle). Although not clearly depicted in FIG. 6, the side inflatable layers 205 are removably secured, attached, and/or affixed to one of a roof panel of the vehicle, one of the plurality of first (and/or second) through-slots 120 and 125 (or 160 and 165 of the second inflatable layer 155, or the like), or one of the one or more straps 135, and/or the like, via at least one top hook 225b (not shown).

The first inflatable layer 115 (and slots 120 and 125), the at least one front hook 150a (and connecting strap(s) 145a), the side inflatable layers 205, and the side straps 220 (and hooks 225a) of FIG. 6 are otherwise similar, if not identical, to the first inflatable layer 115 (and slots 120 and 125), the at least one front hook 150a (and connecting strap(s) 145a), the side inflatable layers 205, and the side straps 220 (and hooks 225a), respectively, of FIG. 5, and the description of these components of FIG. 5 are otherwise applicable to the corresponding components of FIG. 6.

Although not shown in the figures, an alternative embodiment of the vehicle hail protector might comprise a vehicle-facing layer that is form-fitted to particular models of vehicles (not unlike conventional car covers, or the like), which might be removably covered over the vehicle and held in place via elastic bands or via hooks (e.g., front, rear, and/or side straps with front, rear, and/or side hooks as shown in FIGS. 4 and 6, or the like), or both, that latch onto at least portions of the bottom of the vehicle. At least one inflatable layer might be disposed, might be affixed to, or might extend from at least portions of the vehicle-facing layer outward from the vehicle (such that the vehicle-facing layer is sandwiched between the vehicle and the at least one inflatable layer, when the vehicle hail protector is covering the vehicle). In use cases, an air pump and wire connections for the air pump (for inflating and/or deflating the at least one inflatable layer) might be integrated in the vehicle hail protector. For parked vehicles, the air pump and/or wire connections for the air pump might be configured to be accessible to external wiring or external/outdoor electrical sockets, or wires/cables extending from the integrated air pump might be of sufficient length (or might be coiled/uncoiled, or might be extendably retractable) to connect to external wiring or external/outdoor electrical sockets, or the like. Alternative to air pumps, the at least one inflatable layer might be configured to be self-inflating when caps sealing air outlets of the at least one inflatable layer have been uncapped, where capping such air outlets after self-inflation would allow for air to be held in the air pockets of the at least one inflatable layer; in such embodiments, the at least one inflatable layer may be deflated by uncapping the caps and rolling the at least one inflatable layer to push out air, where capping such air outlets after deflation would prevent air from entering the air pockets of the at least one inflatable layer. According to some embodiments, alternative or additional to use of a power cables to connect to electrical outlets to power the one or more air pumps, the one or more air pumps might (further) comprise at least one of one or more batteries, one or more solar cells, one or more other power generators, and/or the like, to supply power to the one or more air pumps to inflate the at least one inflatable layer.

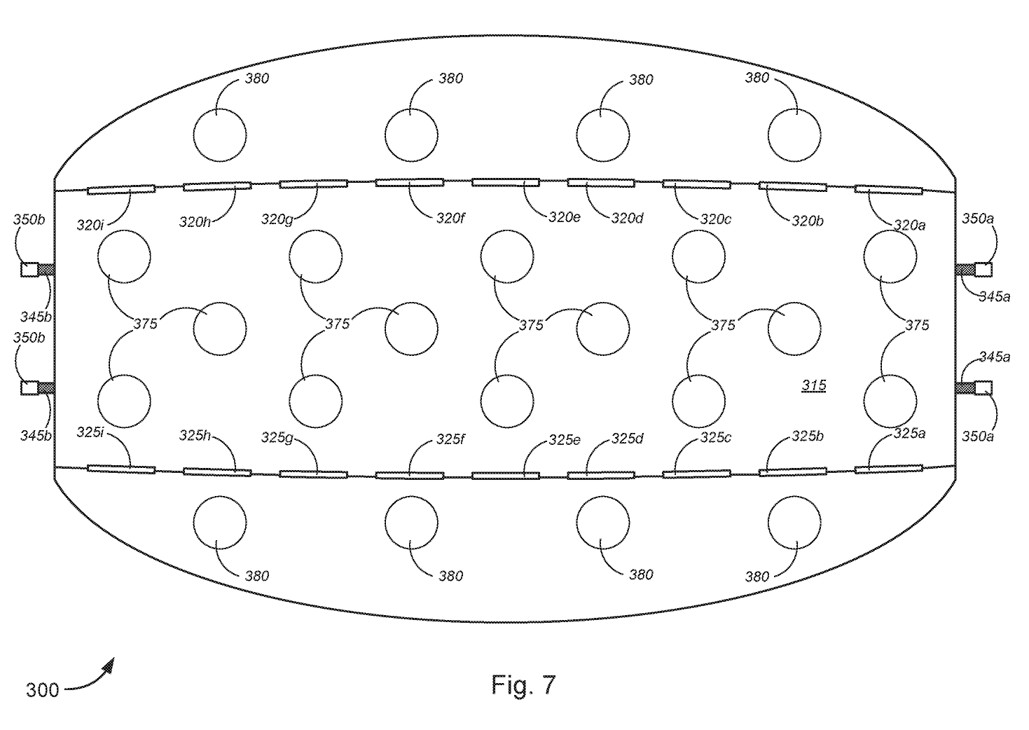

FIG. 7 is a schematic diagram illustrating a top or bottom view of yet another embodiment 300 of a system for implementing vehicle and personal hail protection for placement over a vehicle. As described above, FIG. 7 depicts inflatable layer 315, which, although not shown, may be disposed over (and in some cases, directly or indirectly on) a vehicle (e.g., vehicle 105 or the like). In the non-limiting embodiment of FIG. 7, the inflatable layer 315 comprises slots 320a-320i (collectively, “slots 320”) that are each paired with, and each symmetric about a center line with respect to, slots 325a-325i (collectively, “slots 325”). As slot pair 320e and 325e may be located near the B-pillar 110b of the vehicle 105 of FIG. 1 when the inflatable layer 315 is placed over vehicle 105, one of the straps 135b might be looped through slots 320e and 325e, and subsequently (although not shown) looped through either the front windows or the back windows near the B-pillar 110b such that the coupling devices 140a and 140b can be coupled together under the roof panel of the vehicle 105. Similarly, as slot pair 320g and 325g is located near the C-pillar 110c of the vehicle 105 when the inflatable layer 315 is placed over vehicle 105, another of the straps 135a might be looped through slots 320g and 325g, and subsequently (although not shown) looped through the back windows near the C-pillar 110c such that the coupling devices 140a and 140b can be coupled together under the roof panel of the vehicle 105. For longer vehicles, more straps might be looped through other pairs of slots and through windows or other openings near other pillars 110 (not shown) of the vehicle to further secure the inflatable layer 315 (and any other inflatable layers (not specifically shown)) over or on the vehicle 105.

The at least one front hook 350a (which may be connected to the inflatable layer 315 by connecting strap(s) 345a) may be removably secured, affixed, or attached to a front portion(s) of the vehicle 105 (i.e., to the front bumper, to one or more front tow hooks, or to the chassis under or behind the front bumper, or the like) (not shown in FIG. 7). Likewise, the at least one rear hook 350b (which may be connected to the inflatable layer 315 by connecting strap(s) 345b) may be removably secured, affixed, or attached to a rear portion(s) of the vehicle 305 (i.e., to the rear bumper, to one or more rear tow hooks, or to the chassis under or in front of the rear bumper, or the like) (not shown).

In some embodiments, a plurality of first dimples 375 (or hemispherical protrusions or the like) might be disposed on a surface of a top surface or a bottom surface of inflatable layer 315. If the plurality of first dimples 375 are disposed on the surface of the bottom surface of the inflatable layer 315, the plurality of first dimples 375 may rest on the roof of vehicle 105. The dimples 375 provide at least one of breathability, decreasing points of contact between the inflatable layer 315 and the roof of vehicle 105, or an air pocket between the inflatable layer 315 and the roof of vehicle 105, and/or the like.

The inflatable layer 315 (and slots 320 and 325), the at least one front hook 350a (and connecting strap(s) 345a), and the at least one rear hook 350b (and connecting strap(s) 345b) of FIG. 7 are otherwise similar, if not identical, to the first inflatable layer 115 (and slots 120 and 125), the at least one front hook 150a (and connecting strap(s) 145a), and the at least one rear hook 150b (and connecting strap(s) 145b) of FIG. 3, respectively, and the description of these components of FIG. 3 are otherwise applicable to the corresponding components of FIG. 7. According to some embodiments, a plurality of second dimples 380 (or hemispherical protrusions or the like) might be disposed on the surface of the top surface or the bottom surface of the inflatable layer 315. If the inflatable layer 315 is disposed on the roof of vehicle 105, the dimples 380 might provide at least one of breathability, decreasing points of contact between the inflatable layer 315 and the sides of vehicle 105, or an air pocket between the inflatable layer 315 and the sides of vehicle 105, and/or the like, should the side portions of the inflatable layer 315 be pressed against the sides of the vehicle 105 due to wind or hail, or the like. In some embodiments, the dimples 375 and/or 380 might be of any suitable size or shape, so as to provide at least one of breathability, decreasing points of contact between the inflatable layer 315 and the roof of vehicle 105, or an air pocket between the inflatable layer 315 and the roof of vehicle 105, and/or the like.

For inflatable layers having a top surface that includes a reflective layer for reflecting sunlight (so as to minimize heating of the vehicle due to solar heat), dimples 375 and/or 380 that are disposed on the top surface of the inflatable layer 315 may likewise be provided with a reflective coating or layer. With the dimples 375 and/or 380 having such reflective surfaces, sunlight (or the light from other sources) may be diffused so as not to blind people around the vehicle 105.

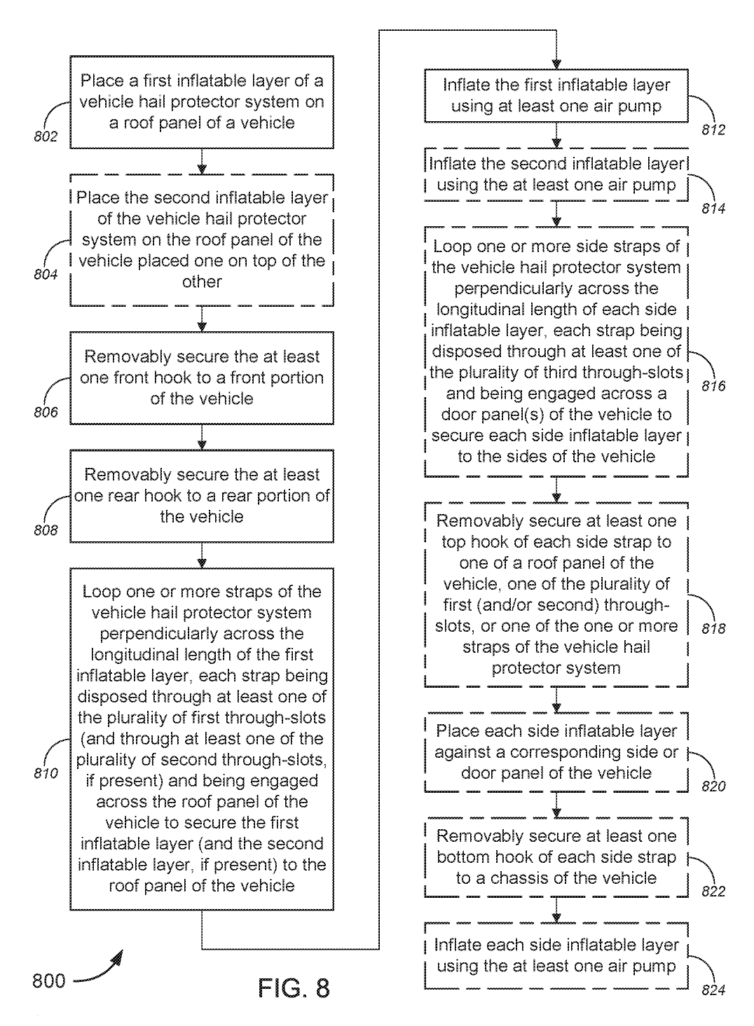

FIG. 8 is a flow diagram illustrating a method 800 for implementing vehicle and personal hail protection, in accordance with various embodiments.

While the techniques and procedures are depicted and/or described in a certain order for purposes of illustration, it should be appreciated that certain procedures may be reordered and/or omitted within the scope of various embodiments. Moreover, while the method 800 illustrated by FIG. 8 can be implemented by or with (and, in some cases, are described below with respect to) the systems or embodiments 100, 200, and 300 of FIGS. 1-7 (or components thereof), such methods may also be implemented using any suitable hardware (or software) implementation. Similarly, while each of the systems or embodiments 100, 200, and 300 of FIGS. 1-7 (or components thereof), can operate according to the method 800 illustrated by FIG. 8 (e.g., by executing instructions embodied on a computer readable medium), the systems or embodiments 100, 200, and 300 of FIGS. 1-7 can each also operate according to other modes of operation and/or perform other suitable procedures.

In the non-limiting embodiment of FIG. 8, method 800, at block 802, might comprise placing a first inflatable layer of a vehicle hail protection system on a roof panel of a vehicle, the first inflatable layer having a front end, a rear end, and sides. The first inflatable layer might include, without limitation, a plurality of first through-slots arrayed along at least a portion of a longitudinal length of the first inflatable layer extending from the front end to the rear end; at least one front hook extending from the front end of the first inflatable layer; and at least one rear hook extending from the rear end of the first inflatable layer.

At optional block 804, method 800 might comprise placing a second inflatable layer of the vehicle hail protection system on the roof panel of the vehicle placed one on top of the other with respect to the first inflatable layer.

Method 800 might further comprise removably securing the at least one front hook to a front portion of the vehicle (block 806); removably securing the at least one rear hook to a rear portion of the vehicle (block 808); and looping one or more straps of the vehicle hail protection system perpendicularly across the longitudinal length of the first inflatable layer, each strap being disposed through at least one of the plurality of first through-slots (and through at least one of the plurality of second through-slots, if present) and being engaged across the roof panel of the vehicle to secure the first inflatable layer (and the second inflatable layer, if present) to the roof panel of the vehicle (block 810).

Alternatively, as described above with respect to FIG. 1, with multiple inflatable layers, the multiple inflatable layers may first be layered one on top of the other, the one or more straps may then be looped through the appropriate (and corresponding) slots in each of the stacked inflatable layers, then the one or more straps are lashed through the windows of the vehicle so that the complementary coupling devices at the ends of each strap can couple to each other on the underside of the roof panel near one of the pillars of the vehicle (to secure the multiple inflatable layers to the roof of the vehicle), and subsequently, the front and rear hooks may be used to removably secure the multiple inflatable layers to the front and rear portions of the vehicle (similar to the processes at blocks 806 and 808). The latter two steps may be reversed in order, as necessary or as desired.

Method 800 might comprise, at block 812, inflating the first inflatable layer using at least one air pump. At optional block 814, method 800 might comprise inflating the second inflatable layer using the at least one air pump (or a different air pump(s)).

According to some embodiments, method 800 might further comprise looping one or more side straps of the vehicle hail protection system perpendicularly across the longitudinal length of each side inflatable layer, each strap being disposed through at least one of the plurality of third through-slots and being engaged across a door panel(s) of the vehicle to secure each side inflatable layer to the sides of the vehicle (optional block 816). At optional block 818, method 800 might comprise removably securing at least one top hook of each side strap to one of a roof panel of the vehicle, one of the plurality of first (and/or second) through-slots, or one of the one or more straps of the vehicle hail protection system. Method 800, at optional block 820, might comprise placing each side inflatable layer against a corresponding side or door panel of the vehicle. Method 800 might further comprise removably securing at least one bottom hook of each side strap to the chassis of the vehicle (optional block 822) and inflating each side inflatable layer using the at least one air pump (optional block 824).

In some embodiments, the at least one air pump might include, but is not limited to, a power plug configured to plug into one of a cigarette lighter socket, a universal serial bus (“USB”) port, or an electrical outlet (e.g., 100 V outlet, 110 V outlet, 120 V outlet, 220 V outlet, or 100-220 V outlet, etc.), and/or the like. At least one of the cigarette lighter socket, the USB port, or the electrical outlet might be disposed within the vehicle and power to the power plug is supplied by a vehicle battery. In some cases, alternative or additional to use of a power plug to power the at least one air pump, the at least one air pump might (further) comprise at least one of one or more batteries, one or more solar cells, one or more other power generators, and/or the like, to supply power to the at least one air pump to inflate the inflatable layer(s). According to some embodiments, the at least one air pump might be disposed within at least one of the first inflatable layer or the second inflatable layer. Alternatively, the at least one air pump might be disposed external to each of at least one of the first inflatable layer or the second inflatable layer, where the at least one air pump is disposed within the vehicle. In some instances, the second inflatable layer might comprise a material having a different durability or function compared with the material of the first inflatable layer. In some cases, the first inflatable layer might comprise a top surface made of a material that is light-weight, airtight, and waterproof, and/or the like. According to some embodiments, the material might include, without limitation, at least one of polyester fibers, nylon fibers, polypropylene fibers, polyethylene terephthalate (“PET”), biaxially-oriented polyethylene terephthalate (“BoPET”), polyvinyl chloride (“PVC”), urethane, rubber, laminate composites, Mylar®, Kevlar®, Conex®, Nomex®, Twaron®, Spectra®, Vectran®, cotton duck fabric, or cotton twill fabric, and/or the like. In some cases, the material might comprise a metal coating or the like. In some instances, the material might be made of a material that protects against at least one of solar radiation, snow, or hail, and/or the like.

Merely by way of example, in some cases, the first inflatable layer has at least one of an ovoid shape, an elliptical shape, or a rectangular shape, or the like. In some instances, the first inflatable layer has one of a convex or vehicle shape. In some embodiments, the plurality of first through-slots are arranged in pairs symmetrically with respect to a central axis parallel with the longitudinal length of the first inflatable layer, wherein each of the one or more straps are disposed through each pair of the at least one of the plurality of first through-slots.

According to some embodiments, the one or more straps engaging across the roof panel of the vehicle might each comprise a pair of coupling devices that, when engaged with each other, secure the first inflatable layer to the roof panel of the vehicle, where the pair of coupling devices might comprise one of a pair of complementary Velcro straps, a pair of complementary buckles, a pair of complementary clips, a set of ratchet strap and ratchet, a set of strap and plastic buckle, or a set of belt and buckle, and/or the like.

The first inflatable layer might further comprise at least one front hook extending from the front end of the first inflatable layer and at least one rear hook extending from the rear end of the first inflatable layer, the at least one front hook might be configured to removably affix the first inflatable layer to a front portion of the vehicle, the at least one rear hook configured to removably affix the first inflatable layer to a rear portion of the vehicle. Each of one or more of the at least one front hook or the at least one rear hook might comprise a hook end and a connecting strap that connects the hook end to the first inflatable layer. The hook end might include, but is not limited to, one of a metal hook, a plastic hook, a carabiner clip, or a clamp, and/or the like. The connecting strap might include, without limitation, one of an elastic cord, a set of ratchet strap and ratchet, a set of Velcro strap and loop with built-in hook connector, a set of strap, loop with built-in hook connector, and plastic buckle, or a set of belt, loop with built-in hook connector, and buckle, and/or the like.

While certain features and aspects have been described with respect to exemplary embodiments, one skilled in the art will recognize that numerous modifications are possible. For example, the methods and processes described herein may be implemented using hardware components, software components, and/or any combination thereof. Further, while various methods and processes described herein may be described with respect to particular structural and/or functional components for ease of description, methods provided by various embodiments are not limited to any particular structural and/or functional architecture but instead can be implemented on any suitable hardware, firmware and/or software configuration. Similarly, while certain functionality is ascribed to certain system components, unless the context dictates otherwise, this functionality can be distributed among various other system components in accordance with the several embodiments.

Moreover, while the procedures of the methods and processes described herein are described in a particular order for ease of description, unless the context dictates otherwise, various procedures may be reordered, added, and/or omitted in accordance with various embodiments. Moreover, the procedures described with respect to one method or process may be incorporated within other described methods or processes; likewise, system components described according to a particular structural architecture and/or with respect to one system may be organized in alternative structural architectures and/or incorporated within other described systems. Hence, while various embodiments are described with—or without—certain features for ease of description and to illustrate exemplary aspects of those embodiments, the various components and/or features described herein with respect to a particular embodiment can be substituted, added and/or subtracted from among other described embodiments, unless the context dictates otherwise. Consequently, although several exemplary embodiments are described above, it will be appreciated that the invention is intended to cover all modifications and equivalents within the scope of the following claims.

What is claimed is:

1. A vehicle hail protection system, comprising:
a first inflatable layer having a front end, a rear end, and sides, comprising:
a plurality of first through-slots arrayed along at least a portion of a longitudinal length of the first inflatable layer extending from the front end to the rear end;
one or more straps; and
at least one air pump, when operable, causing the first inflatable layer to be inflated;
wherein when the first inflatable layer is disposed on a roof panel of a vehicle, the one or more straps are disposed perpendicularly across the longitudinal length of the first inflatable layer, each strap being disposed through at least one of the plurality of first through-slots, wherein the one or more straps are engaged across the roof panel of the vehicle to secure the first inflatable layer to the roof panel of the vehicle.

2. The vehicle hail protection system of claim 1, wherein the at least one air pump comprises a power plug configured to plug into one of a cigarette lighter socket, a universal serial bus (“USB”) port, or an electrical outlet, wherein at least one of the cigarette lighter socket, the USB port, or the electrical outlet is disposed within the vehicle and power to the power plug is supplied by a vehicle battery.

3. The vehicle hail protection system of claim 1, further comprising:
a second inflatable layer, comprising:
a plurality of second through-slots arrayed along at least a portion of a longitudinal length of the second inflatable layer, wherein when the first inflatable layer and the second inflatable layer are disposed one layer over the other, the plurality of first through-slots are aligned with the plurality of second through-slots;
wherein each of the one or more straps are disposed through at least one first through-slot of the plurality of first through-slots and through at least one second through-slot of the plurality of second through-slots aligned with the at least one first through-slot, wherein the at least one first through-slot and the at least one second through-slot through which each strap is disposed are aligned with each other.

4. The vehicle hail protection system of claim 3, wherein the at least one air pump is disposed within at least one of the first inflatable layer or the second inflatable layer.

5. The vehicle hail protection system of claim 3, wherein the at least one air pump is disposed external to each of at least one of the first inflatable layer or the second inflatable layer, wherein the at least one air pump is disposed within the vehicle.

6. The vehicle hail protection system of claim 3, wherein the second inflatable layer comprises a material having a different durability or function compared with the material of the first inflatable layer.

7. The vehicle hail protection system of claim 1, wherein the first inflatable layer comprises a top surface made of a material that is light-weight, airtight, and waterproof.

8. The vehicle hail protection system of claim 7, wherein the material comprises at least one of polyester fibers, nylon fibers, polypropylene fibers, polyethylene terephthalate (“PET”), biaxially-oriented polyethylene terephthalate (“BoPET”), polyvinyl chloride (“PVC”), urethane, rubber, laminate composites, Mylar®, Kevlar®, Conex®, Nomex®, Twaron®, Spectra®, Vectran®, cotton duck fabric, or cotton twill fabric.

9. The vehicle hail protection system of claim 8, wherein the material comprises a metal coating.

10. The vehicle hail protection system of claim 8, wherein the material is made of a material that protects against at least one of solar radiation, snow, or hail.

11. The vehicle hail protection system of claim 1, wherein the first inflatable layer has at least one of an ovoid shape, an elliptical shape, or a rectangular shape.

12. The vehicle hail protection system of claim 1, wherein the first inflatable layer has one of a convex or vehicle shape.

13. The vehicle hail protection system of claim 1, wherein the plurality of first through-slots are arranged in pairs symmetrically with respect to a central axis parallel with the longitudinal length of the first inflatable layer, wherein each of the one or more straps are disposed through each pair of the at least one of the plurality of first through-slots.

14. The vehicle hail protection system of claim 1, wherein the one or more straps engaging across the roof panel of the vehicle each comprises a pair of coupling devices that, when engaged with each other, secures the first inflatable layer to the roof panel of the vehicle, wherein the pair of coupling devices comprises one of a pair of complementary Velcro straps, a pair of complementary buckles, a pair of complementary clips, a set of ratchet strap and ratchet, a set of strap and plastic buckle, or a set of belt and buckle.

15. The vehicle hail protection system of claim 1, wherein the first inflatable layer further comprises at least one front hook extending from the front end of the first inflatable layer and at least one rear hook extending from the rear end of the first inflatable layer, the at least one front hook configured to removably affix the first inflatable layer to a front portion of the vehicle, the at least one rear hook configured to removably affix the first inflatable layer to a rear portion of the vehicle.

16. The vehicle hail protection system of claim 15, wherein each of one or more of the at least one front hook or the at least one rear hook comprises a hook end and a connecting strap that connects the hook end to the first inflatable layer, wherein the hook end comprises one of a metal hook, a plastic hook, a carabiner clip, or a clamp, wherein the connecting strap comprises one of an elastic cord; a set of ratchet strap and ratchet; a set of Velcro strap and loop with built-in hook connector; a set of strap, loop with built-in hook connector, and plastic buckle; or a set of belt, loop with built-in hook connector, and buckle.

17. The vehicle hail protection system of claim 1, further comprising:
at least two side inflatable layers, each comprising a plurality of third through-slots arrayed along at least a portion of a longitudinal length of the side inflatable layer;
wherein when each of the at least two side inflatable layers are disposed along each side of the vehicle, one or more side straps are disposed perpendicularly across the longitudinal length of each side inflatable layer, each side strap being disposed through at least one of the plurality of third through-slots, wherein the one or more side straps are engaged across a door panel of the vehicle to secure each side inflatable layer to the sides of the vehicle, wherein one end of each side strap couples to a chasis of the vehicle while the other end of each side strap couples to one of the first inflatable layer or a strap of the one or more straps securing the first inflatable layer to the roof panel of the vehicle.

18. A method, comprising:
placing a first inflatable layer of a vehicle hail protection system on a roof panel of a vehicle, the first inflatable layer having a front end, a rear end, and sides, wherein the first inflatable layer comprises:
a plurality of first through-slots arrayed along at least a portion of a longitudinal length of the first inflatable layer extending from the front end to the rear end;
at least one front hook extending from the front end of the first inflatable layer; and
at least one rear hook extending from the rear end of the first inflatable layer;
removably securing the at least one front hook to a front portion of the vehicle;
removably securing the at least one rear hook to a rear portion of the vehicle;
looping one or more straps of the vehicle hail protection system perpendicularly across the longitudinal length of the first inflatable layer, each strap being disposed through at least one of the plurality of first through-slots and being engaged across the roof panel of the vehicle to secure the first inflatable layer to the roof panel of the vehicle; and
inflating the first inflatable layer using at least one air pump.

19. The method of claim 18, wherein the vehicle hail protection system further comprises a second inflatable layer, comprising a plurality of second through-slots arrayed along at least a portion of a longitudinal length of the second inflatable layer, the method further comprises placing the second inflatable layer on the roof panel of the vehicle placed one on top of the other with respect to the first inflatable layer; wherein when the first inflatable layer and the second inflatable layer are disposed one layer over the other, the plurality of first through-slots are aligned with the plurality of second through-slots; wherein each of the one or more straps are disposed through at least one first through-slot of the plurality of first through-slots and through at least one second through-slot of the plurality of second through-slots aligned with the at least one first through-slot, wherein the at least one first through-slot and the at least one second through-slot through which each strap is disposed are aligned with each other.

20. The method of claim 18, wherein looping the one or more straps comprises looping the one or more straps near at least one of an A pillar, a B pillar, a C pillar, or a D pillar of the vehicle.
